(19) United States
(12) Patent Application Publication
(10) Pub. No.: US 2019/0135407 A1
(43) Pub. Date: May 9, 2019

(54) Cargo hold and vehicle section

(71) Applicant: Airbus Operations GmbH, Hamburg (DE)

(72) Inventor: Claus-Peter Gross, Hamburg (DE)

(21) Appl. No.: 15/999,171

(22) Filed: Aug. 17, 2018

(30) Foreign Application Priority Data
Aug. 17, 2017 (DE) 10 2017 118 782.0

(51) Int. Cl. B64C 1/22

(52) U.S. Cl. CPC B64C 1/22

(57) ABSTRACT

A cargo hold for a vehicle, comprising a first wall and a second wall lying opposite the first wall, a pivotable floor element arranged between the two walls, and a spring device coupled to the floor element. The second wall is closer to the first wall in a longitudinal direction of the cargo hold perpendicularly with respect to the first wall in a first state of the cargo hold than in a second state. The floor element is in a first position in the first state and in a second position in the second state. An angle enclosed by the floor element with a plane parallel to the first wall is smaller in the first position than in the second position. The spring device is coupled to the floor element such that it is prestressed when the cargo hold is expanded from its first state into its second state.

### CROSS-REFERENCES TO RELATED APPLICATIONS

This application claims the benefit of the German patent application No. 10 2017 118 782.2 filed on Aug. 17, 2017, the entire disclosures of which are incorporated herein by way of reference.

### BACKGROUND OF THE INVENTION

The present invention relates to an expandable cargo hold and to a vehicle section having a cargo hold of this type.

Modern vehicles such as airplanes or trains can make the simultaneous transportation of cargo and passengers possible. Therefore, the space which is available in the interior of the vehicle is usually divided into a passenger compartment and a cargo hold. For example, in airplanes which are known from the prior art with two decks (see, for example, document EP 0 681 956 A1), the upper deck can form a passenger compartment, whereas cargo is transported in the lower deck (that is to say, the main deck). The cargo, for example the luggage of the passengers, can be stowed directly in the cargo hold of the airplane or in additional containers or pallets before the airplane is loaded with the latter. An additional container of this type is described, for example, in document DE 10 2007 062 873 A1.

After the vehicle (for example, the passenger airplane) has reached its destination, the passengers leave the airplane and the cargo is unloaded at the gate. Afterward, the airplane can be serviced and can be prepared by the ground staff and/or cabin crew for the following flight, it being possible, inter alia, for the seat configuration of the passenger cabin to be adapted, in order that the available space is utilized in an improved manner. In order to keep the direct operating costs of the airplane as low as possible, which operating costs rise as the turnaround time rises, it is desirable that the measures are carried out rapidly and simply.

### SUMMARY OF THE INVENTION

Against this background, it is an object of the invention to provide a cargo hold, the size of which can be changed rapidly and simply by the ground staff or the cabin crew. Furthermore, the invention is concerned with an object of providing a vehicle section having a cargo hold of this type.

The expandable cargo hold is provided for a vehicle (for example, an airplane or a train) and comprises a first cargo hold wall and a second cargo hold wall which lies opposite the first cargo hold wall, a pivotable first floor element which is arranged between the first and the second cargo hold wall, and a first spring device which is coupled to the first floor element. The second cargo hold wall is arranged closer to the first cargo hold wall in a longitudinal direction of the cargo hold perpendicularly with respect to the first cargo hold wall in a first state of the cargo hold than in a second state of the cargo hold. The first floor element is arranged in a first position in the first state of the cargo hold and is arranged in a second position in the second state of the cargo hold. An angle which is enclosed by the first floor element with a first plane which is parallel to the first cargo hold wall is smaller in the first position of the first floor element than in the second position of the first floor element. Furthermore, the first spring device is coupled to the first floor element in such a way that it is prestressed when the cargo hold is expanded/enlarged from its first state into its second state. Moreover, the second cargo hold wall can be arranged spaced apart further from the first cargo hold wall in the longitudinal direction of the cargo hold in a third state of the cargo hold than in the first and in the second state.

As the prestress of the first spring device increases, a force which counteracts the movement of the first floor element out of the first position into the second position grows, with the result that the movement of the first floor element is absorbed and the first floor element is impeded effectively from coming into contact with an object which is arranged below the cargo hold, for example an intermediate floor or cabin floor of the vehicle. The spring force which is induced by the prestress can in turn assist the movement of the first floor element out of its second position into its first position, with the result that the user can reduce the cargo hold from its second state into its first state with a smaller force effort.

The first and the second cargo hold wall and/or the first floor element can be arranged, for example, substantially transversely in the vehicle. In particular, the two cargo hold walls can run parallel to one another. The first spring device is preferably coupled to a first frame part which is arranged between the first and the second cargo hold wall or directly to the second cargo hold wall, in such a way that the first spring device is prestressed by way of movement of the first frame part or the second cargo hold wall in the longitudinal direction. For this purpose, the first spring device can be connected, for example rigidly, to the first cargo hold wall and the second cargo hold wall or the first frame part and a second frame part of the cargo hold which is arranged closer to the first cargo hold wall than the first frame part. For example, in the region of a first one of its ends, the first spring device can be fastened to the first cargo hold wall, to the second frame part or to a component of the vehicle, which component is situated outside the cargo hold. Furthermore, in the region of a second end which is opposite with respect to the first end, the first spring device can be fastened to the second cargo hold wall, for example to a lateral outer side of the second cargo hold wall, or to the first frame part. The first frame part can be configured in one piece with the second cargo hold wall.

In one preferred variant, the first spring device is coupled via the first frame part or the second cargo hold wall to the first floor element. To this end, not only the first spring device can be connected to the first cargo hold wall or the first frame part as indicated above, but rather also the first floor element. It is conceivable, in particular, that the first floor element is configured in one piece or multiple pieces. The first floor element preferably comprises a first section which can be pivoted about a first axis which runs parallel to the first cargo hold wall. The first axis can run, for example, along the first cargo hold wall, along the second frame part of the cargo hold, which second frame part is connected to the first cargo hold wall, or along a floor part which extends from the first cargo hold wall. If the first axis runs along the first cargo hold wall, the first floor element can be fastened to the first cargo hold wall in the region of the first axis. Furthermore, the first floor element can have a second section which can be capable of being pivoted relative to the first section about a second axis which runs parallel to the first axis.

The first floor element is preferably coupled to the first frame part or the second cargo hold wall in such a way that the first floor element is pivoted correspondingly from its first position into its second position by way of movement of the first frame part or the second cargo hold wall, for example in the longitudinal direction. In this case, the first spring device can optionally be set up to be prestressed at the same time as the movement and the pivoting. This is advantageously achieved by the first floor element having the first and the second section, and the second section additionally being fastened to the second cargo hold wall or the first frame part such that it can be pivoted about a third axis which is parallel to the first and second axis.

The coupling of the two sections of the first floor element to the first spring device and the second cargo hold wall/the first frame part achieves a situation where the staff can simply expand the cargo hold, by displacing the second cargo hold wall/the first frame part in the longitudinal direction. The movement in the longitudinal direction is assisted by way of the weight of the first floor element, and the first spring device is prestressed at the same time. In order to reduce the cargo hold out of the second state into the first state, the staff can lift the first floor element in the region of the second axis by means of a holding device, for example by means of a bar or cable. The prestressed first spring device assists the lifting operation, with the result that weights of approximately 30 N (instead of approximately 300 N without a spring device) are to be overcome in practice, in order to move the first floor element into its first position and the cargo hold into its first state.

The first spring device can comprise, for example, a spring, in particular a helical spring or gas pressure spring. If the first spring device comprises a spring, the spring constant of the spring preferably lies in the range from 100 to 350 N/m. The spring constant can be, for example, at least 150 N/m, at least 170 N/m or at least 180 N/m. At the same time, the spring constant can be at most 300 N/m, at most 250 N/m or at most 220 N/m. The spring constant very preferably lies in the range from 150 N/m to 250 N/m. It can be, for example, approximately 200 N/m. The prestress/spring force of the first spring device preferably increases linearly with the deflection of the first spring device out of its rest position. If the first spring device comprises a helical spring, it is preferably received in a housing in the region of the first or second end of the first spring device and is guided in the longitudinal direction as a result. The first spring device is preferably designed in such a way that the spring force which is exerted by it acts parallel to the longitudinal direction. This is achieved in a simple and efficient way if the first spring device is prestressed in the longitudinal direction, with the result that the spring force which acts at the second end of the spring device (that is to say, the spring force vector) is oriented counter to the longitudinal direction.

The first spring device is preferably substantially prestress-free/relieved, that is to say is situated in its rest position, when the cargo hold is situated in the first state. Substantially prestress-free means here that the first spring device does not exert any appreciable spring force in comparison with the forces which are required to move the second cargo hold wall, the first frame part or the first floor element relative to the first cargo hold wall. As a result, the first floor element can be deflected relatively easily out of its first position when the cargo hold is expanded from the first state into the second state. In the reverse case, when the cargo hold is moved from the second state into the first state, the spring force which is exerted by the first spring device is reduced toward the end of the movement, with the result that the first floor element can reach its first position in a comparatively gentle way.

It is provided in a further variant that the first spring device has a setting apparatus which is set up to change a prestress of the first spring device. In particular, the setting apparatus is set up to change the prestress of the first spring device while the cargo hold is situated in the first or second state, for example without the second cargo hold wall moving relative to the first cargo hold wall. In this way, the movement-assisting action of the first spring device can be increased or decreased, with the result that the size of the cargo hold can be changed even more comfortably. The setting apparatus can be set up, for example, to prevent the first spring device from reaching its prestress-free rest position. To this end, the setting apparatus can have, for example, a holding section which is connected fixedly to the first end of the first spring device and can be moved counter to the longitudinal direction by means of a screw apparatus, in order to stretch and thus to prestress the first spring device. In order to relieve the first spring device, the screw apparatus can be actuated in such a way that the holding section is moved in the longitudinal direction.

Furthermore, at least one part of a cargo loading system for the vehicle can be arranged on the first floor element. The cargo loading system can comprise one or more rails which extend, in particular, in the longitudinal direction and are provided with rollers for cargo pallets or containers. When the cargo hold is situated in the second state, the rails are preferably arranged on a side of the first floor element, which side faces the interior of the cargo hold. Preferably at least two, very preferably at least four of the rails run parallel to one another. It can be provided, furthermore, that a spring travel, by which the first spring device is deflected out of its prestress-free rest position when the cargo hold is situated in the second state, is directly proportional to the difference between the spacing of the second cargo hold wall from the first cargo hold wall in the second state and the spacing of the second cargo hold wall from the first cargo hold wall in the first state.

In one development, furthermore, the cargo hold comprises a second spring device and a second floor element which is coupled to the second spring device. In this case, the second floor element can be situated in a first position in the first or second state of the cargo hold, and can be situated in a second position in the third state of the cargo hold. An angle which is enclosed by the second floor element with a second plane which is parallel to the first cargo hold wall is preferably smaller in the first position of the second floor element than in the second position of the second floor element. Moreover, the second spring device can be coupled to the second floor element in such a way that it is prestressed when the cargo hold is expanded from its first or second state into its third state. Moreover, it is conceivable that the cargo hold has one or more further spring devices and in each case one further floor element which is coupled to one of the spring devices. Each of the further spring devices can have any desired features of the second spring device which is described here. Furthermore, each of the further floor elements can have any desired features of the second floor element which is described here.

If the cargo hold has the second spring device, it can additionally comprise a linear guide system which is set up to guide at least one part of the second spring device in the longitudinal direction. The linear guide system can have a sleeve which is attached on an outer face of the cargo hold and a guide rod which is attached on the second spring device and is in engagement with the sleeve. The guide rod can extend in the longitudinal direction and can be capable of being moved in the longitudinal direction relative to the sleeve. Moreover, it is conceivable that the linear guide system has a guide rail which is arranged in the surrounding area of the cargo hold, extends in the longitudinal direction, and in which a spring housing of the second spring device is guided in the longitudinal direction.

In a further variant, the first and/or second spring device comprise/comprises a first spring with a first spring constant and a second spring with a second spring constant which is lower than the first spring constant. The second spring can optionally comprise a stretching limiting apparatus which is set up to limit the spring travel of the second spring. The stretching limiting apparatus can be, for example, a cable. The cable can extend in the interior of the second spring. The movement of the cargo hold between the first and the second state can take place in a more continuous manner if the stiffer first spring is not deflected considerably until the second spring has reached the spring travel limiting means.

Furthermore, it is conceivable that the cargo hold is arranged in a separate shell which seals the cargo hold in a substantially gastight, watertight and/or hermetic manner with respect to its surroundings.

A vehicle section comprises a cargo hold which is described in detail in the above text. The vehicle section can be, in particular, an airplane section. The airplane section can be, for example, an airplane section of a two-floor airplane with one or more aisles. The cargo hold is preferably arranged in the passenger cabin, in the main floor or on a lower level. A cargo hold which is arranged in the shell is preferably installed on the lowermost level of the airplane section, in order that it lies below the waterline in the case of emergency ditching in water. In this case, the shell also serves as a barrier against penetrating water.

### BRIEF DESCRIPTION OF THE DRAWINGS

Preferred embodiments of a cargo hold and a vehicle section will now be described more precisely with reference to the appended diagrammatic drawings, in which:

FIGS. 1a and 1b show a first embodiment of a cargo hold in its first state in a side view and a perspective view,

FIGS. 2a and 2b show the cargo hold from FIG. 1a in its second state in a side view and a perspective view,

FIGS. 3a to 3c show a second embodiment of a cargo hold in its first state in a side view, a front view of the second cargo hold wall, a view of the floor of the cargo hold from below, and a perspective view,

FIGS. 4a to 4c show the cargo hold from FIG. 3a in its second state in a side view, a front view of the second cargo hold wall, a view of the floor of the cargo hold from below, and a perspective view,

FIGS. 5a and 5b show the first and second spring device of the cargo hold from FIG. 3a in the installed position, the cargo hold being situated in its first state in FIG. 5a and in its third state in FIG. 5b,

FIGS. 5c and 5d show the first and second spring device of the cargo hold from FIG. 3a separately in a detailed view,

FIGS. 6a and 6b show a third embodiment of a cargo hold in its first and third state,

FIGS. 6c and 6d show the first and second spring device of the cargo hold from FIG. 6a separately in a detailed view,

FIGS. 7a and 7b show a fourth embodiment of a cargo hold in its first and third state,

FIGS. 7c and 7d show the first and second spring device of the cargo hold from FIG. 7a separately in a detailed view,

FIGS. 8a to 8c show the first and second spring device of the cargo holds from FIGS. 3a, 6a and 7a in the assembled state,

FIGS. 9a and 9b show components of the first and second spring device of a fifth embodiment of a cargo hold in the relieved and prestressed state, and

FIG. 10 shows one embodiment of a vehicle section.

### DETAILED DESCRIPTION OF THE PREFERRED EMBODIMENTS

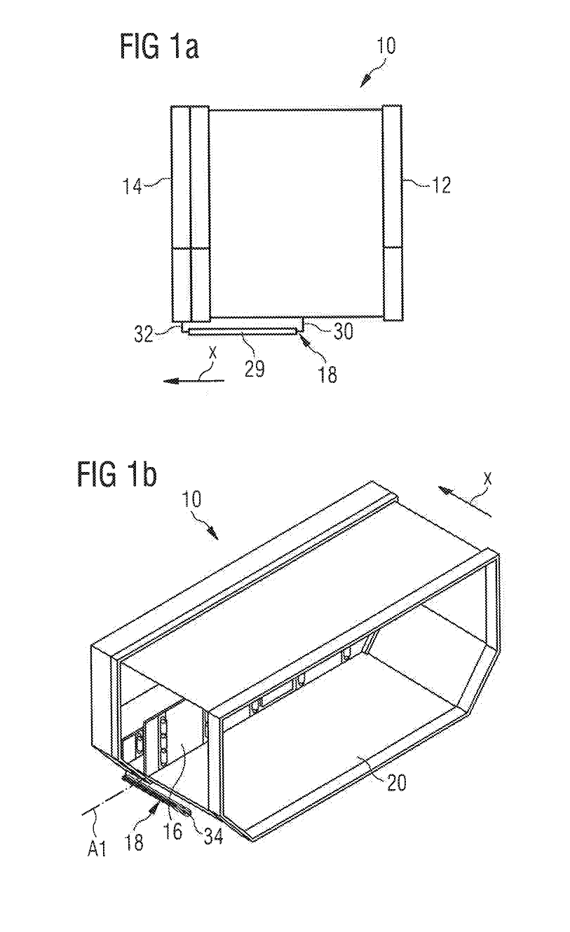

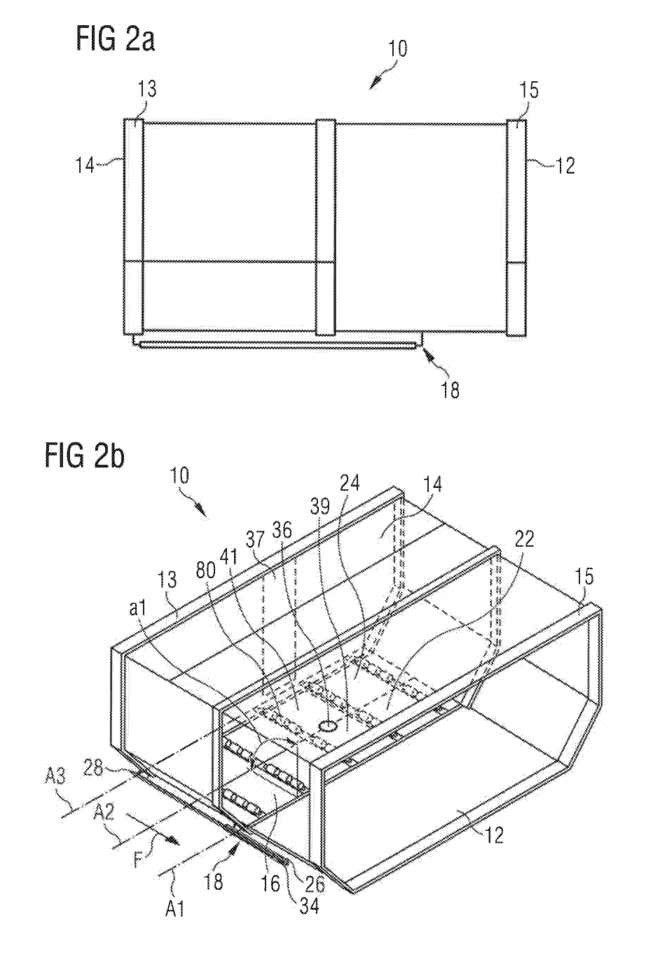

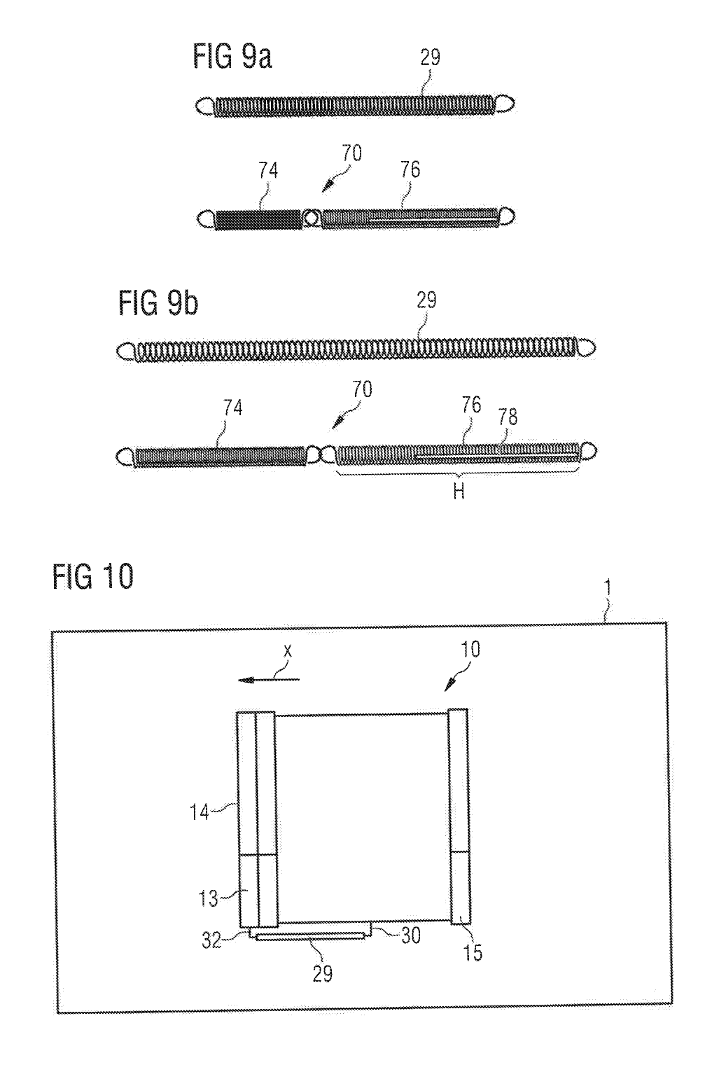

FIGS. 1a to 2b show a first embodiment of an expandable cargo hold 10. The cargo hold 10 is provided for a vehicle, in particular for an airplane, and can be arranged or installed in a vehicle section 1 (see FIG. 10). The cargo hold 10 comprises a first cargo hold wall 12 and a second cargo hold wall 14 which lies opposite the first cargo hold wall 12. Here, the cargo hold walls 12, 14 are outer walls of the cargo hold 10. A pivotable first floor element 16 which is coupled to a first spring device 18 is arranged between the first and the second cargo hold walls 12, 14. The first floor element 16 can be pivoted about a first axis A1 which runs parallel to the first cargo hold wall 12. Moreover, the first floor element 16 is fastened to a floor part 20 which is arranged between the axis A1 and the first cargo hold wall 12. As viewed along their/its main plane, the first and/or second cargo hold wall 12, 14 have/has a cross-sectional shape which corresponds to the cross-sectional shape of an air cargo container.

A spacing in the longitudinal direction X of the cargo hold 10 between the first cargo hold wall 12 and the second cargo hold wall 14 is smaller in a first state (shown in FIGS. 1a and 1b) of the cargo hold 10 than in a second state (shown in FIGS. 2a and 2b) of the cargo hold 10. Here, the longitudinal direction X runs perpendicularly with respect to the first cargo hold wall 12. Moreover, a first angle a1 which is enclosed by the first floor element 16 with a first plane which contains the axis A1 and is parallel to the first cargo hold wall 12 and to the second cargo hold wall 14 is smaller when the first floor element 16 is situated in the first state of the cargo hold 10 (see FIG. 1b) than when the first floor element 16 is situated in the second state of the cargo hold (see FIG. 2b). The angle a1 can be, for example, from 0° to 10° in the first state and from 80° to 100° in the second state. It is preferably approximately 0° in the first state and approximately 90° in the second state. In the first state, the first floor element 16 can therefore be oriented substantially parallel to, and in the second state substantially perpendicularly with respect to, the first or second cargo hold wall 12, 14.

In this example, the first floor element 16 comprises a first section 22 and a second section 24. The first angle a1 is that angle, at which the first section 22 crosses the first plane. The second section 24 is mounted on the first section 22 such that it can be rotated about a second axis A2. Moreover, the second section 24 is mounted on a first frame part 13 which runs parallel to the second cargo hold wall 14, such that it can be rotated about a third axis A3. The second and the third axis A2, A3 run parallel to the first axis A1. When the cargo hold 10 is situated in its second state, the first section 22 is oriented in a coplanar manner with respect to the second section 24, with the result that the first and the second section 22, 24 are part of the flat floor of the cargo hold 10.

The first spring device 18 extends in the longitudinal direction X between a first end 26 which is adjacent with respect to the first cargo hold wall 12 and a second end 28 which is opposite the first end 26. In the region of the second end 28 of the first spring device 18, the latter is coupled to the first frame part 13 in such a way that a deflection of the first frame part 13 in the longitudinal direction X results in the same deflection of the second end 28 of the first spring device 18 in the longitudinal direction X. In contrast, the first end 26 of the first spring device 18 is stationary in the reference system of the first cargo hold wall 12, a second frame part 15 which is parallel to the first cargo hold wall 12, or the floor part 20. The first end 26, the floor part 20, the second frame part 15 and/or the first cargo hold wall 12 can be set up to be mounted in a stationary manner in the reference system of the vehicle or vehicle section 1.

In order to enlarge the cargo hold 10 out of its first state into its second state, the second cargo hold wall 14 is moved in the longitudinal direction X. The first spring device 18 is coupled by way of the above-described arrangement to the first floor element 16 and the first frame part 13 in such a way that it is prestressed by the cargo hold 10 being extended out of its first state into its second state, that is to say the first floor element 16 being folded into its second position and the second cargo hold wall 14 being moved in the longitudinal direction X.

When the first spring device 18 is prestressed, it exerts a spring force F which is oriented counter to the longitudinal direction X at the second end 28, that is to say pulls the second end 28 of the first spring device 18 counter to the longitudinal direction X. The spring force F likewise acts counter to the longitudinal direction X on the first frame part 13. The spring travel, by which the first spring device 18 is deflected out of its relieved rest position when the cargo hold 10 is situated in the second state, is directly proportional to the difference between the spacing of the second cargo hold wall 14 from the first cargo hold wall 12 in the second state and the spacing of the second cargo hold wall 14 from the first cargo hold wall 12 in the first state. In particular, the spring travel can correspond to the difference.

The cargo hold 10 can be reduced in size out of its second state into its first state by the first floor element 16 being lifted in the region of the axis A2, for example via a holding device 36. Here, the spring force F assists the movement of the second cargo hold wall 14 counter to the longitudinal direction X and the movement of the first floor element 16 into its folded-in first position.

The first spring device 18 comprises a spring 29 which can be configured, for example, as a helical spring or gas pressure spring and is coupled via a first fastening apparatus 30 which is arranged adjacently with respect to the first end 26 to the first cargo hold wall 12 and/or the second frame part 15, and is coupled via a second fastening apparatus 32 which is arranged adjacently with respect to the second end 28 to the second cargo hold wall 14 and/or the first frame part 13. In particular, the first end 26 can be fastened via the fastening apparatus 30 to the floor part 20 or to a component of the vehicle section 1, which component is adjacent with respect to the floor part 20. Furthermore, the second end 28 can be fastened via the fastening apparatus 32 to the second cargo hold wall 14 and/or the first frame part 13.

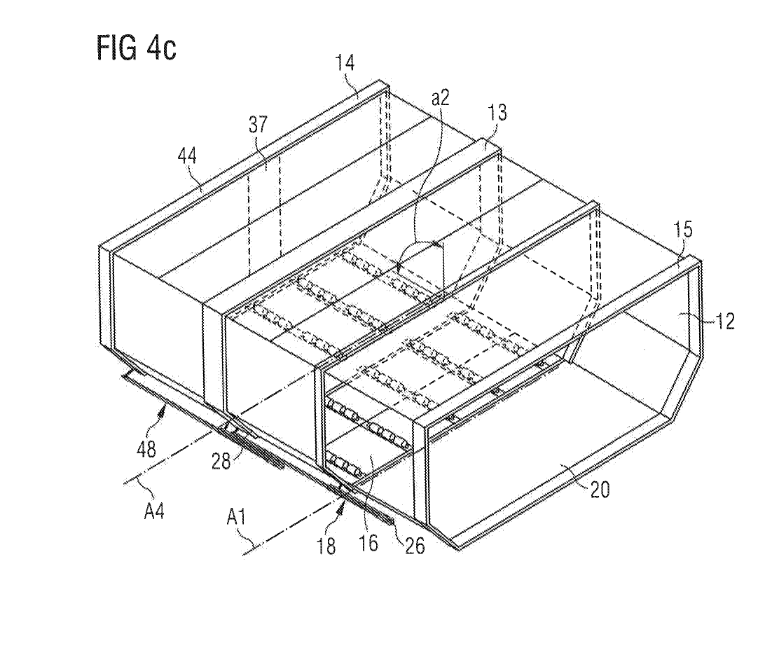

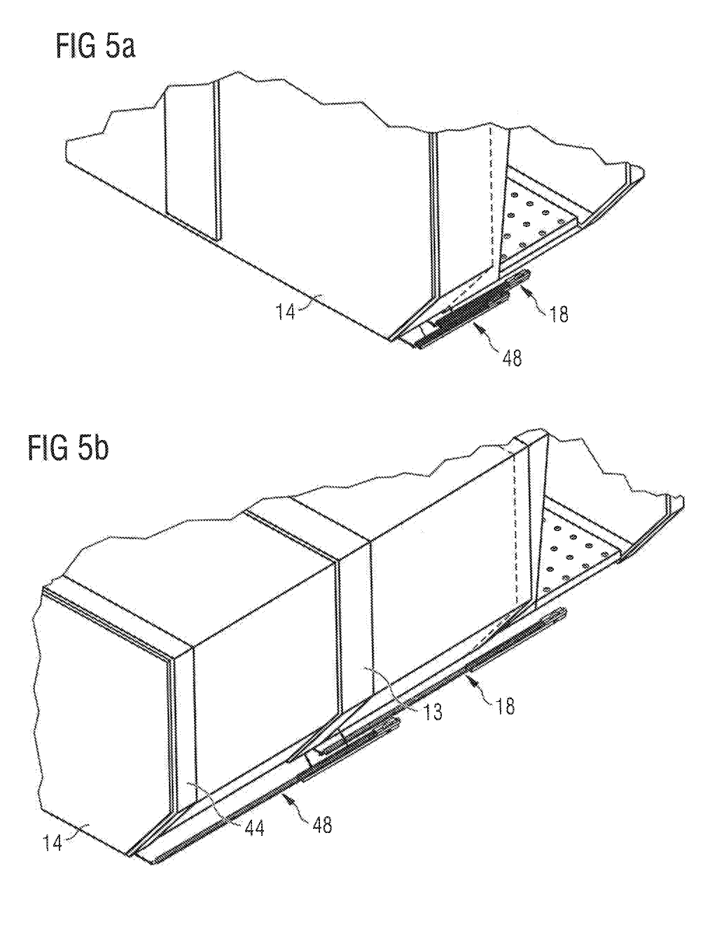

The first spring device 18 is arranged spaced apart with respect to the floor of the cargo hold 10 in an outer region of the cargo hold 10. Therefore, the floor of the cargo hold 10 can lie on a floor surface of the vehicle section 1. Moreover, the first spring device 18 is relieved when the cargo hold 10 is situated in its first state. In other words, the first spring device 18 does not exert any spring force F in this state. In order to prestress the first spring device 18, however, while the cargo hold 10 can remain in its first or second state, the first spring device 18 additionally has a setting apparatus 34 for the spring stress (see, for example, FIGS. 5c and 5d for a detailed view). The setting apparatus 34 is set up to move one of the ends 26, 28 of the first spring device 18 and therefore to change the length of the spring 29. In this variant, the setting apparatus 34 has a holding section (not shown) which is connected fixedly to the first end 26 and can be moved counter to the longitudinal direction X by means of a screw apparatus, in order to stretch and thus to prestress the first spring device 18. In order to relieve the first spring device 18, the screw apparatus can be actuated in such a way that the holding section is moved in the longitudinal direction X. The first spring device 18 has a housing 49, in which the spring 29 is received when the cargo hold 10 is situated in the first state, and from which the spring 29 protrudes partially when the cargo hold 10 is situated in the second state.

Furthermore, the second cargo hold wall 14 has a door 37 which is set up to open into an outer region of the cargo hold 10, in particular in the longitudinal direction X. In its first and second section 22, 24, the first floor element 16 has flaps 39, 41 which, when the cargo hold 10 is situated in the first state, preferably likewise open in the longitudinal direction X. In this state, the door 37 and the flaps 39, 41 make access into the inner region of the cargo hold 10 possible for the staff, by the door 37 and the flaps 39, 41 being opened outward. Here, the flaps 39, 41 are arranged in such a way that they pivot into the door opening of the open door 37.

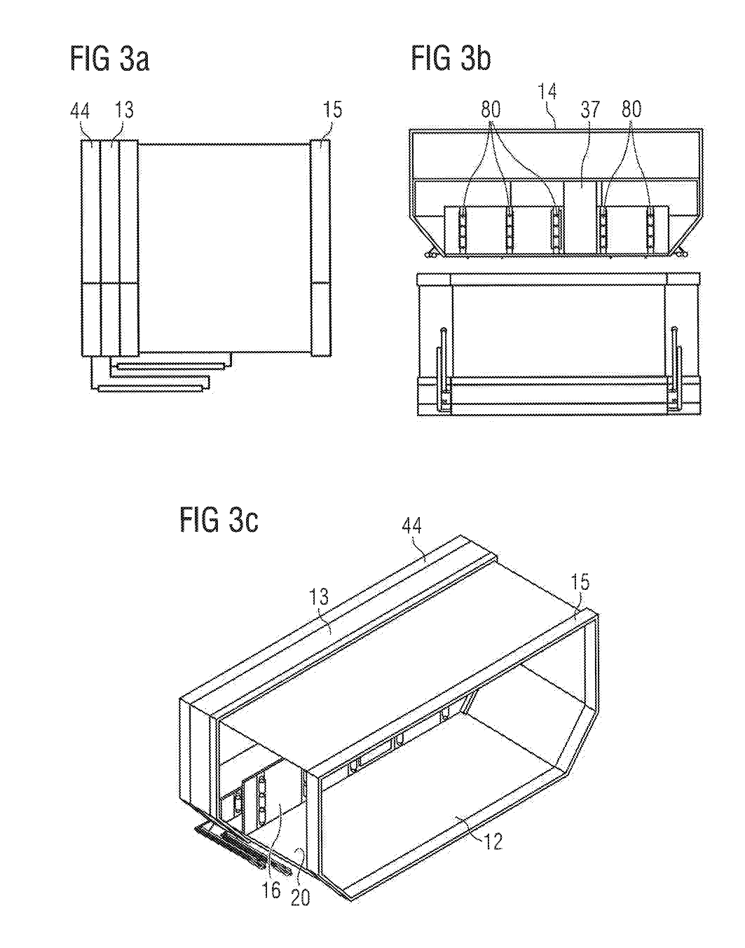

A second embodiment (shown in FIGS. 3a to 5d and 8a) of the cargo hold 10 differs from the cargo hold 10 from FIG. 1a in that the cargo hold 10 in accordance with the second embodiment additionally has a second floor element 38 with a first section 40 and a second section 42, and a third frame part 44 which is arranged parallel to the first frame part 13 and the second frame part 15. The first frame part 13 is arranged between the second frame part 15 and the third frame part 44. The first frame part 13 can be moved relative to the second cargo hold wall 14. Furthermore, in the embodiment, the cargo hold 10 comprises a second spring device 48 and can be expanded into a third state, in which the second cargo hold wall 14 is arranged spaced apart further from the first cargo hold wall 12 in the longitudinal direction X than in the first and in the second state.

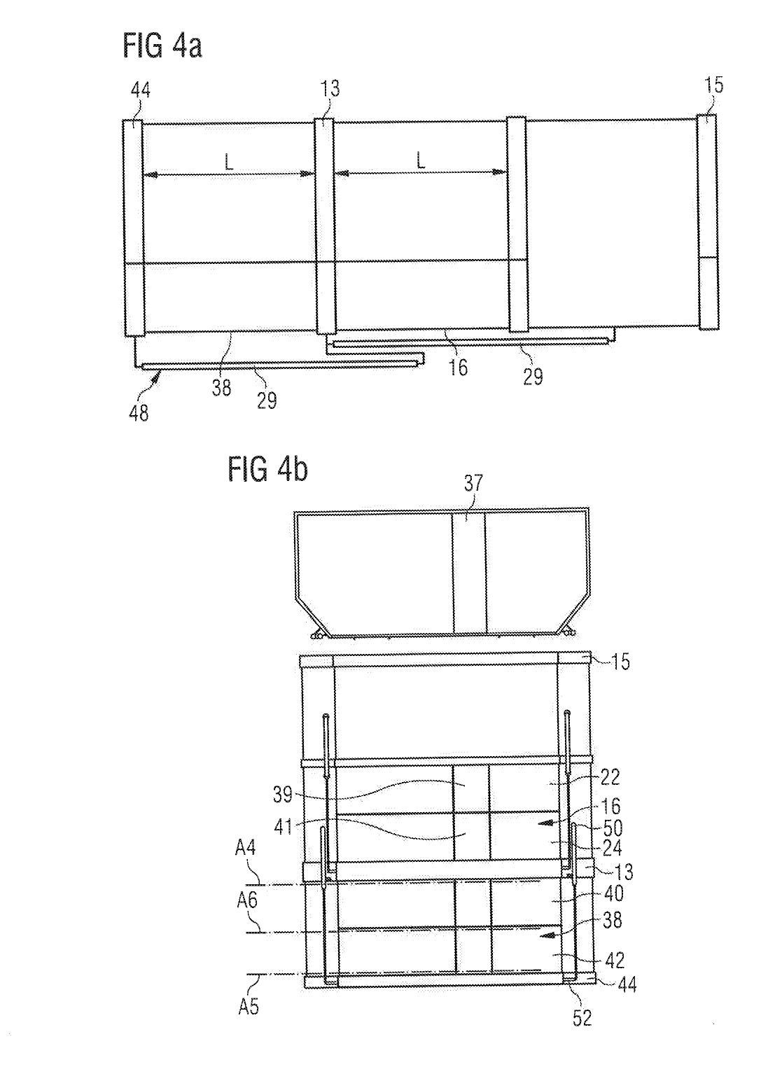

The second floor element 38 is situated in its first position (shown in FIGS. 3b and 3c) when the cargo hold 10 is in its first or second state. In order that, in contrast, the cargo hold 10 reaches its third state (shown in FIGS. 4a to 4c), the second floor element 38 is pivoted about a fourth axis A4 which is parallel to the first axis A1. Before the pivoting, the second floor element 38 assumes its first position, in which an angle a2 which is enclosed by the second floor element 38 and a plane which is parallel to the first cargo hold wall 12 is smaller than in a second position which the second floor element 38 assumes when the cargo hold 10 is situated in the third state.

The second floor element 38 connects the third frame part 44 to the first frame part 13, by the first section 40 of the second floor element 38 being mounted on the first frame part 13 such that it can be pivoted about the fourth axis A4, and by the second section 42 being mounted on the third frame part 44 such that it can be pivoted about a fifth axis A5 which runs parallel to the fourth axis A4, the first section 40 being mounted on the second section 42 such that it can be pivoted about a sixth axis A6 which runs parallel to the fourth axis A4. Otherwise, the second floor element 38 has the same features in relation to the second spring device 48 as the first floor element 16 in relation to the first spring device 18.

The second end 28 of the first spring device 18 is connected rigidly to a first end 50 of the second spring device 48, which first end 50 faces the first cargo hold wall 12. For example, both the second end 28 and the first end 50 can be fastened to the first frame part 13. The second spring device 48 can also have a setting apparatus 34 which is set up to move the first end 50 or a second end 52 of the second spring device 48, which second end 52 is opposite the first end, and therefore to change the length of the spring 29 of the second spring device 48. In this variant, the setting apparatus 34 has a holding section (not shown) which is connected fixedly to the first end 50 and can likewise be moved counter to the longitudinal direction X by means of a screw apparatus, in order to stretch and thus to prestress the second spring device 48. In order to relieve the second spring device 48, the screw apparatus can be actuated in such a way that the holding section is moved in the longitudinal direction X. The second spring device 48 likewise has a housing 49, in which a spring 29 is received when the cargo hold 10 is situated in the first or second state, and from which the spring 29 protrudes partially when the cargo hold 10 is situated in the third state.

Moreover, the cargo hold 10 from FIGS. 3a to 5d and 8a has all the features of the cargo hold 10 from FIGS. 1a to 2b.

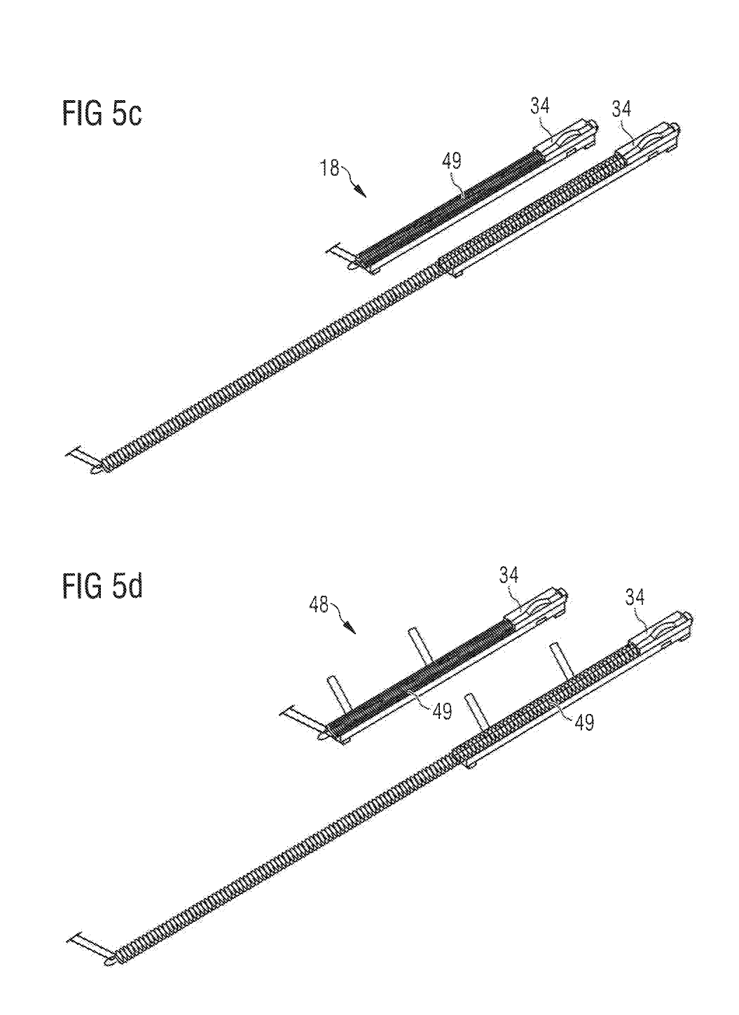

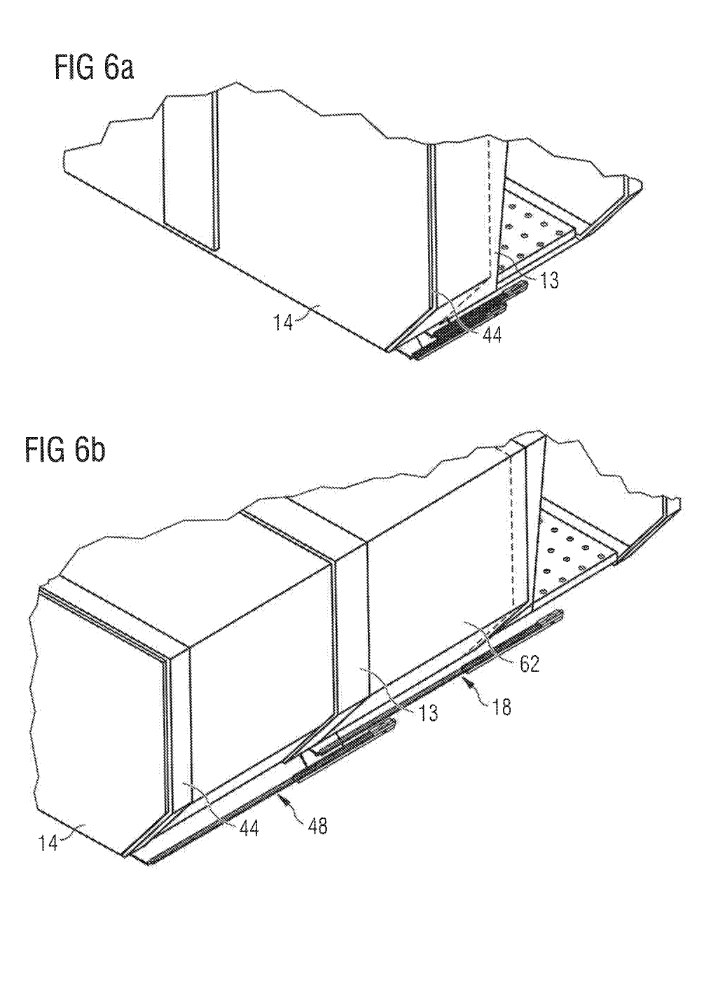

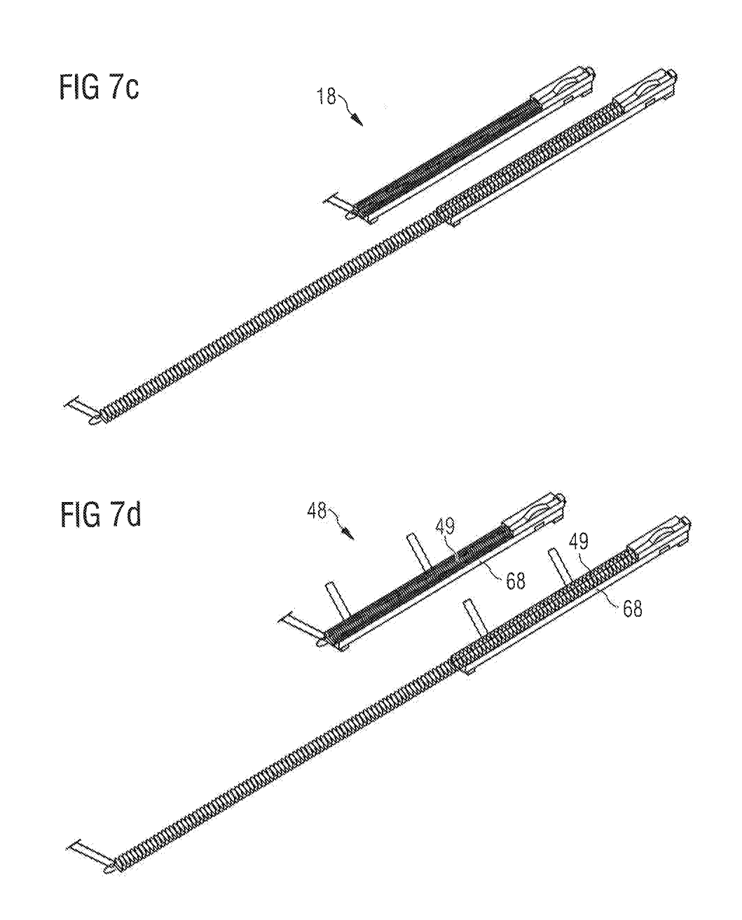

A third embodiment (shown in FIGS. 6a to 6d and 8b) of the cargo hold 10 differs from the cargo hold 10 from FIG. 3a in that the cargo hold 10 in accordance with the third embodiment additionally has a linear guide system 60 which is set up to guide the second spring device 48 in the longitudinal direction X. In the third embodiment, the linear guide system 60 comprises a sleeve 64 which is attached on an outer face 62 of the cargo hold 10, and a guide rod 66 which is fastened to the second spring device 48 and is in engagement with the sleeve 64. Here, both the sleeve 64 and the guide rod 66 have a cylindrical shape. Furthermore, the guide rod 66 is fastened to the housing 49 of the second spring device 48, with the result that the housing 49 moves together with the guide rod 66 in the longitudinal direction X relative to the sleeve 64 when the cargo hold 10 is expanded out of its first state into its second state.

Moreover, the cargo hold 10 from FIGS. 6a to 6d and 8b has all the features of the cargo hold 10 from FIGS. 3a to 5d and 8a.

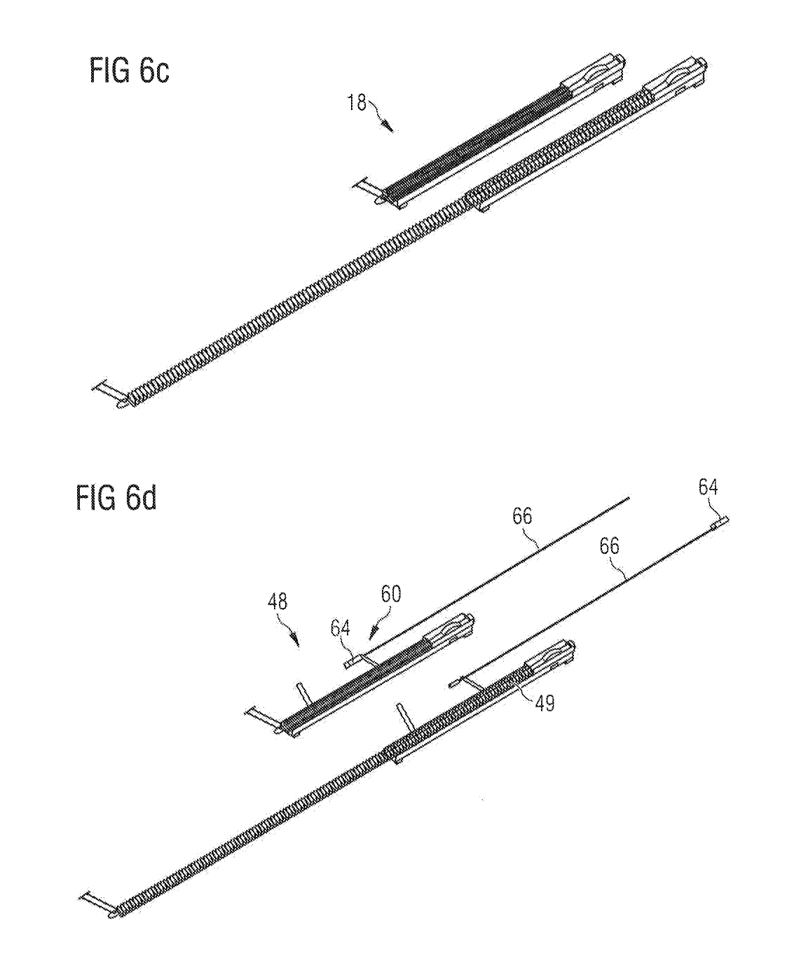

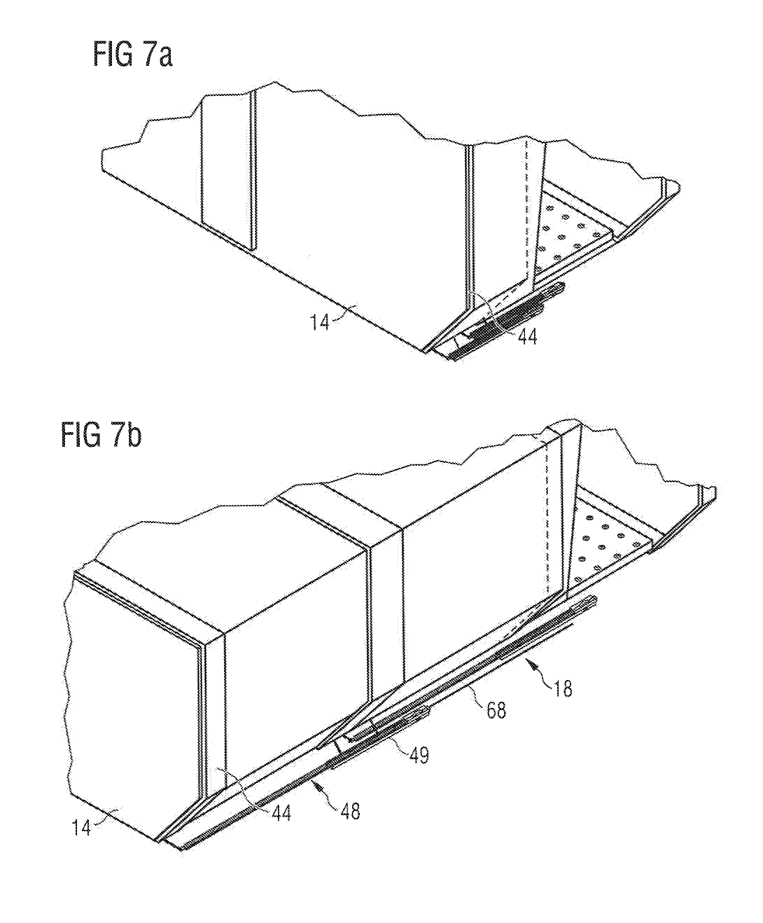

A fourth embodiment (shown in FIGS. 7a to 7d and 8c) of the cargo hold 10 differs by way of the guidance of the housing 49 by the cargo hold 10 from FIG. 6a. In this embodiment, the linear guide system 60 has a rail 68 which can be fastened in the surrounding area of the cargo hold 10, in particular on a floor of the vehicle section 1. As an alternative, the rail 68 can be arranged in a recessed manner in the floor of the vehicle section 1. The housing 49 of the second spring device 48 is received in the rail 68 such that it can be moved in the longitudinal direction.

Moreover, the cargo hold 10 from FIGS. 7a to 7d and 8c has all the features of the cargo hold 10 from FIGS. 3a to 5d and 8a.

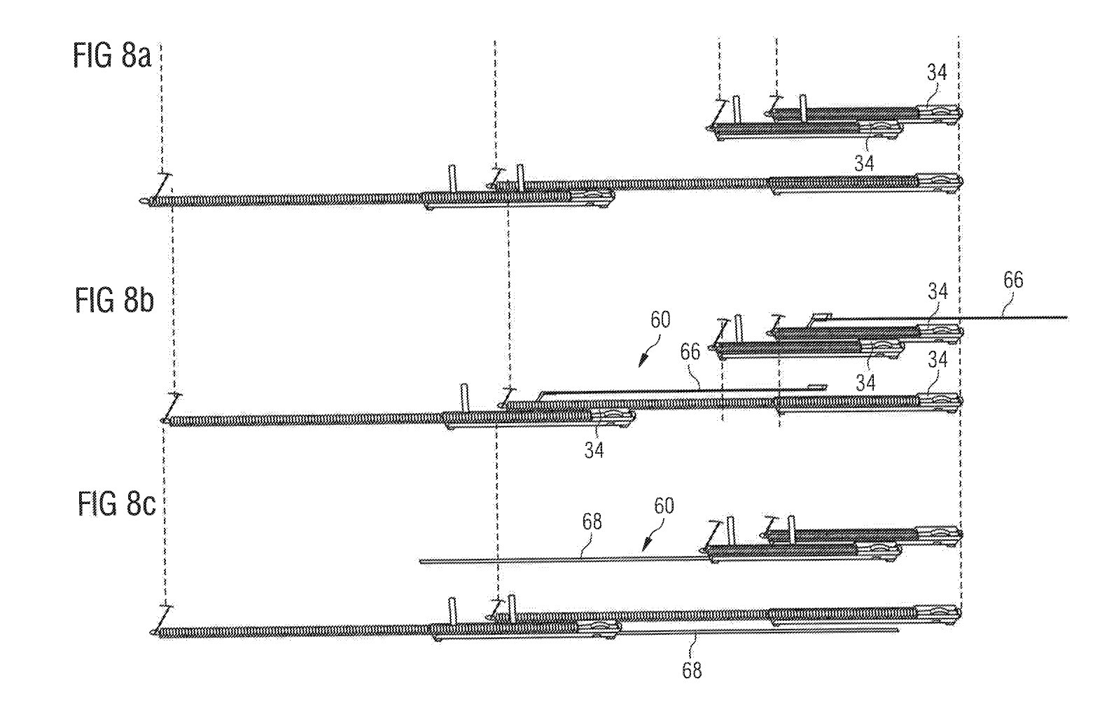

FIGS. 9a and 9b show a spring arrangement 70 of the spring devices 18, 48 of a fifth embodiment of the cargo hold 10, which spring arrangement 70 replaces the respective spring 29 of the above-described spring devices 18, 48. In the embodiment, instead of the spring 29, the first and/or the second spring device 18, 48 comprise/comprises a spring arrangement 70 which has a comparatively stiff first spring 74 and a comparatively soft second spring 76. The first spring 74 has a greater spring constant than the second spring 76. Furthermore, the second spring 76 comprises a stretching limiting apparatus 78 which limits stretching of the second spring 76 to a maximum value H. In this example, the stretching limiting apparatus 78 is configured as a cable, for example as a metal cable. The spring constant of the second spring 76 can be, for example, at most half as great as the spring constant of the first spring 74. The spring constant of the first spring 74 or second spring 76 can lie in the range from 100 to 350 N/m, for example at least 150 N/m, at least 170 N/m or at least 180 N/m. At the same time, the spring constant of the first spring 74 or the second spring 76 can be at most 300 N/m, at most 250 N/m or at most 220 N/m. In this example, the spring constant of the first spring 74 lies in the range from 150 N/m to 250 N/m. It is approximately 200 N/m.

The spring arrangement 70 can be used in all the above-described cargo holds 10 in accordance with the first to fourth embodiment, and can therefore be combined with all the remaining features.

Moreover, the first and the second floor element 16, 38 of each of the above-described embodiments has a part of a cargo loading system for the vehicle. The cargo loading system comprises five rails 80 which extend, in particular, in the longitudinal direction X and are provided with rollers for cargo pallets or containers. When the cargo hold 10 is situated in the second state, the rails 80 are arranged on a side of the floor elements 16, 38, which side faces the interior of the cargo hold 10 (see, for example, FIG. 2b).

In each of the abovementioned embodiments, the length difference L of the cargo hold 10 and/or the first spring device 18 in the longitudinal direction X between the first and the second state and/or between the second and third state is at least 1 m, in particular at least 1.5 m. In order to realize a compact overall design of the first and second spring device 18, 48, the second end 28 of the first spring device 18 in the second to fifth embodiment is spaced apart further from the first cargo hold wall 12 than the first end 50 of the second spring device 48 (cf. FIGS. 4a and 4b).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An expandable cargo hold for a vehicle, comprising
a first cargo hold wall and a second cargo hold wall lying opposite the first cargo hold wall,
a pivotable first floor element arranged between the first and the second cargo hold wall, and
a first spring device coupled to the first floor element,
the second cargo hold wall being arranged closer to the first cargo hold wall in a longitudinal direction of the cargo hold perpendicularly with respect to the first cargo hold wall in a first state of the cargo hold than in a second state of the cargo hold,
the first floor element being situated in a first position in the first state of the cargo hold and being situated in a second position in the second state of the cargo hold, an angle which is enclosed by the first floor element with a first plane which is parallel to the first cargo hold wall being smaller in the first position than in the second position, and
the first spring device being coupled to the first floor element in such a way that it is prestressed when the cargo hold is expanded from its first state into its second state.

2. The cargo hold as claimed in claim 1, wherein the first spring device is coupled to a first frame part arranged between the first and the second cargo hold wall, such that the first spring device is prestressed by way of movement of the first frame part in the longitudinal direction.

3. The cargo hold as claimed in claim 2, wherein the first spring device is coupled via the first frame part to the first floor element.

4. The cargo hold as claimed in claim 2, wherein the first floor element being coupled to the first frame part in such a way that the first floor element is pivoted from its first position into its second position by way of movement of the first frame part in the longitudinal direction, the first spring device being set up to be prestressed at the same time as the movement and the pivoting.

5. The cargo hold as claimed in claim 1, wherein a spring force of the prestressed first spring device is oriented parallel to a longitudinal direction of the vehicle.

6. The cargo hold as claimed in claim 1, wherein the first spring device comprises a spring.

7. The cargo hold as claimed in claim 6, wherein the first spring device comprises a helical spring.

8. The cargo hold as claimed in claim 6, wherein the first spring device comprises a gas pressure spring.

9. The cargo hold as claimed in claim 1, wherein the first spring device is substantially relieved when the cargo hold is situated in the first state.

10. The cargo hold as claimed in claim 1, wherein the first spring device has a setting apparatus which is set up to change a prestress of the first spring device.

11. The cargo hold as claimed in claim 1, wherein at least one part of a cargo loading system for the vehicle is arranged on the first floor element.

12. The cargo hold as claimed in claim 1, wherein a spring travel, by which the first spring device is deflected out of its relieved rest position when the cargo hold is situated in the second state, being directly proportional to a difference between a spacing of the second cargo hold wall from the first cargo hold wall in the second state and a spacing of the second cargo hold wall from the first cargo hold wall in the first state.

13. The cargo hold as claimed in claim 1, further comprising
a second spring device coupled to a second floor element,
the second cargo hold wall being arranged spaced apart further from the first cargo hold wall in the longitudinal direction of the cargo hold in a third state of the cargo hold than in the first and in the second state,
the second floor element being situated in a first position of the second floor element in the first or second state of the cargo hold and being situated in a second position of the second floor element in the third state of the cargo hold, an angle enclosed by the second floor element with a second plane parallel to the first cargo hold wall being smaller in the first position of the second floor element than in the second position of the second floor element,
the second spring device being coupled to the second floor element in such a way that it is prestressed when the cargo hold is expanded from its first or second state into its third state.

14. The cargo hold as claimed in claim 13, further comprising a linear guide system set up to guide at least one part of the second spring device) in the longitudinal direction.

15. The cargo hold as claimed in claim 14, wherein the linear guide system has a sleeve attached on an outer face of the cargo hold and a guide rod attached on the second spring device and is in engagement with the sleeve, the guide rod extending in the longitudinal direction and being capable of being moved in the longitudinal direction relative to the sleeve.

16. The cargo hold as claimed in claim 14, wherein the linear guide system has a guide rail arranged in a surrounding area of the cargo hold, extending in the longitudinal direction, and wherein a spring housing of the second spring device is guided in the longitudinal direction.

17. The cargo hold as claimed in claim 1, wherein at least one of the first or second spring devices comprises a first spring with a first spring constant and a second spring with a second spring constant lower than the first spring constant, and
the second spring comprises a stretching limiting apparatus which is set up to limit a spring travel of the second spring.

18. A vehicle section having a cargo hold as claimed in claim 1.

19. The vehicle section as claimed in claim 18, comprising a section of an aircraft.
